(19) United States
(12) Patent Application Publication
(10) Pub. No.: US 2017/0361394 A1
(43) Pub. Date: Dec. 21, 2017

(54) SYSTEMS AND METHODS FOR PULSED FRICTION AND FRICTION STIR WELDING

(71) Applicants: Cameron International Corporation, Houston, TX (US); Colorado School of Mines, Golden, CO (US)

(72) Inventors: John C. Bartos, Magnolia, TX (US); Zhenzhen Yu, Lakewood, CO (US); Feng Lu, Houston, TX (US)

(21) Appl. No.: 15/541,356

(22) PCT Filed: Dec. 30, 2015
(86) PCT No.: PCT/US2015/068174

§ 371 Date: Jun. 30, 2017

Related U.S. Application Data
(60) Provisional application No. 62/098,212, filed on Dec. 30, 2014.

(51) Int. Cl. B23K 20/12; B23K 20/26

(52) U.S. Cl. CPC B23K 20/125; B23K 20/1285; B23K 20/1255; B23K 20/123; B23K 20/1235; B23K 20/129; B23K 20/26

(57) ABSTRACT

A system includes a tool configured to be positioned proximate to respective welding surface of separate components. The tool includes a tool head and an actuator configured to drive rotation of the tool head. The tool also includes a controller having a memory operatively coupled to a processor. The processor is configured to provide a command signal to the actuator to apply a pulsed torque to drive rotation of the tool head to facilitate joining the respective welding surfaces of the separate components to one another.

### CROSS-REFERENCE TO RELATED APPLICATION

This application claims the benefit of U.S. Provisional Patent Application No. 62/098,212, filed Dec. 30, 2014, entitled “SYSTEMS AND METHODS FOR PULSED FRICTION AND FRICTION STIR WELDING,” which is incorporated by reference herein in its entirety.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

A variety of machines may be used to couple components to one another. For example, components may be coupled together via a filler material and/or by melting the components together (e.g., via welding, soldering, or brazing techniques). Unfortunately, existing machines used to join components to one another may be large, complex, and/or costly.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a schematic illustration of a friction stir welding system, in accordance with an embodiment of the present disclosure;

FIG. 2 is a schematic illustration of a friction welding system, in accordance with an embodiment of the present disclosure;

FIG. 3 is a graph showing torque pulses that may be applied by the friction stir welding system of FIG. 1 or the friction welding system of FIG. 2, in accordance with an embodiment of the present disclosure; and

FIG. 4 is a flow diagram of a method for joining components via the friction stir welding system of FIG. 1 or the friction welding system of FIG. 2, in accordance with an embodiment of the present disclosure.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Friction welding (FW) and friction stir welding (FSW) are solid-state welding techniques used to join components to one another. Such techniques do not melt the components, but rather, use mechanical friction to generate heat and to mechanically join the components to one another. In general, FW joins a moving component to a stationary component by rotating the moving component as the components are urged together. FSW generally utilizes a tool to join adjacent surfaces of separate components. The tool includes a tool head that is rotated and moved laterally across a joint between the adjacent surfaces, and the frictional heat and mechanical forces cause the adjacent surfaces to join to one another. Unfortunately, FW and FSW systems generally apply high continuous torque to effectively join the components to one another. As a result, FW and FSW systems are large, complex, and/or costly.

Accordingly, certain embodiments of the present disclosure include a FSW system or a FW system configured to apply pulsed torque to join components to one another. In particular, the FSW system includes a tool having a tool head and a pin that is configured to be placed adjacent to surfaces of the components. The pin applies a pulsed torque (e.g., rotates through separate discrete angles of rotation) as the pin moves along a joint between the surfaces of the components, thereby joining the components to one another. The FW system includes a tool having a rotating tool head (e.g., shaft) configured to support a movable component. The rotating shaft and the movable component attached thereto are positioned adjacent to a stationary component. A pulsed torque rotates the rotating shaft, and, thus, rotates the attached movable component, through separate discrete angles of rotation as the movable component is pressed (e.g., urged) against the stationary component, thereby joining the movable component and the stationary component to one another. Without the disclosed embodiments, FW and FSW systems apply a continuous or generally steady (e.g., having a generally constant magnitude) torque to join components to one another. In order to apply the continuous torque and withstand corresponding reaction forces, the FW and FSW systems utilize large and/or expensive components. In accordance with the disclosed embodiments, applying pulsed torque enables the disclosed FW and FSW systems to effectively join components with smaller, less complex, and/or less expensive parts. In some cases, the FW and FSW systems may be portable (e.g., handheld), enabling such systems to be utilized in a wide variety of applications.

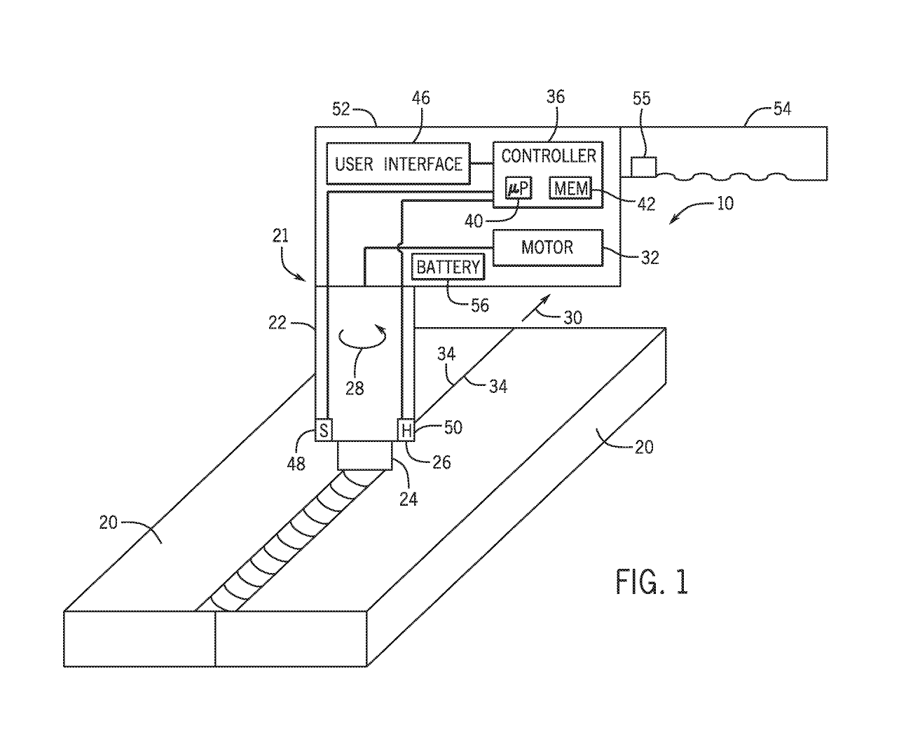

With the foregoing in mind, FIG. 1 illustrates an embodiment of a friction stir welding (FSW) system 10 configured to employ a pulsed torque to join separate components 20 (e.g., components of a valve, such as a ball valve) to one another. As shown, the FSW system 10 includes a FSW tool 21 having a tool head 22 (e.g., a cylindrical rotary tool) having a pin 24 extending from a bottom surface 26 of the tool head 22. The tool head 22 is configured to rotate, as shown by arrow 28, and to translate relative to the components 20, as shown by arrow 30. As shown, the FSW system 10 includes an actuator 32 that is configured to drive rotation and/or translation of the tool head 22. The actuator 32 may be any suitable actuator (e.g., an electric motor, air motor, hydraulic drive, combustion engine, or the like) and may be configured to apply a pulsed torque to drive the tool head 22 through multiple discrete angles of rotation, as discussed in more detail below. When placed in contact with adjacent surfaces 34 (e.g., welding surfaces) of the components 20, such movement of the tool head 22 causes the surfaces 34 to heat and to plastically deform, thereby joining the components 20 to one another.

As shown, the FSW system 10 also includes a controller 36. In certain embodiments, the controller 36 is an electronic controller having electrical circuitry configured to process data from various components of the FSW system 10, for example. In the illustrated embodiment, the controller 36 includes a processor, such as the illustrated microprocessor 40, and a memory device 42. The controller 36 may also include one or more storage devices and/or other suitable components. The processor 40 may be used to execute software, such as software for controlling the actuator 32 to drive rotation of the tool head 22, and so forth. Moreover, the processor 40 may include multiple microprocessors, one or more “general-purpose” microprocessors, one or more special-purpose microprocessors, and/or one or more application specific integrated circuits (ASICS), or some combination thereof. For example, the processor 40 may include one or more reduced instruction set (RISC) processors.

The memory device 42 may include a volatile memory, such as random access memory (RAM), and/or a nonvolatile memory, such as ROM. The memory device 42 may store a variety of information and may be used for various purposes. For example, the memory device 42 may store processor-executable instructions (e.g., firmware or software) for the processor 40 to execute, such as instructions for controlling the actuator 32 and/or the tool head 22. The storage device(s) (e.g., nonvolatile storage) may include read-only memory (ROM), flash memory, a hard drive, or any other suitable optical, magnetic, or solid-state storage medium, or a combination thereof. The storage device(s) may store data (e.g., torque data, etc.), instructions (e.g., software or firmware for controlling the actuator 32 and/or the tool head 22, etc.), and any other suitable data.

In certain embodiments, the controller 36 is configured to control the actuator 32 to apply a predetermined pulsed torque (e.g., at a predetermined frequency and/or magnitude stored in the memory 42). However, in some embodiments, the controller 36 may be configured to adjust the applied pulsed torque based on various factors or inputs. For example, it may be desirable to apply the pulsed torque at one frequency when the components 20 are formed from certain materials, while it may be desirable to apply the pulsed torque at another frequency when the components 20 are formed from different materials. Accordingly, the controller 36 may be configured to receive various inputs (e.g., from a user interface 46 and/or from one or more sensors 48) and to control the actuator 32 based on the inputs. For example, the user interface 46 may enable an operator to input various data, such as a material type, and the data may be received at the controller 36. By way of another example, the one or more sensors 48 may monitor a temperature at the adjacent surfaces 34 of the components 20 and may provide signals indicative of the temperature to the controller 36. Based on the inputs and/or signals, the controller 36 may then determine and/or select suitable parameters (e.g., frequency and/or magnitude) for the pulsed torque to be applied by the tool head 22 and may send appropriate instructions to the actuator 32 to drive the tool head 22 according to the suitable parameters. In some embodiments, the controller 36 may additionally or alternatively send instructions to the actuator 32, or to another suitable actuator, to adjust a transverse speed (e.g., in direction 30) based on the inputs and/or signals. Thus, the parameters (e.g., frequency and/or magnitude) of the pulsed torque and/or the transverse speed may be set or adjusted based a material composition of one or more of the components 20, a material composition of the pin 24, a thickness of the components 20, a desired penetration depth (e.g., desired depth of a joint between the components 20), a desired width of the joint, a width of the pin 24, a temperature at the adjacent surfaces 34, or any other suitable factor or combination thereof. In some embodiments, the transverse speed may be controlled by the operator manually moving the portable FSW system 10 transversely, as shown by arrow 30. In such cases, the one or more sensors 48 may be configured to monitor the transverse speed and provide a signal indicative of the transverse speed to the controller 36, while the controller 36 may be configured to receive the signal and select or adjust parameters for the pulsed torque based on the transverse speed, for example.

In some embodiments, the FSW system 10 may also include a heating element 50 (e.g., ceramic heating element, conductive contact element, fan to blow hot air, or the like), which may be configured to apply heat to the adjacent surfaces 34 of the components 20 to facilitate joining the components 20 to one another. In such cases, the temperature may not melt the components 20 (e.g., the temperature is below the melting point of the material), but rather may facilitate plastic deformation of the components 20 and increase welding efficiency. Heat applied by the heating element 50 may be controlled by the controller 36. In some cases, the heat applied by the heating element may be controlled based on data, such as the material type, an applied pulsed torque, a transverse speed, and/or the temperature, or any other type of data listed above, received at the controller 36.

As shown, in some embodiments, some or all of the actuator 32, the controller 36, the user interface 46, and/or any other components of the FSW system 10 may be disposed within a housing 52. For example, the FSW system 10 may be a portable and/or a handheld system, and an operator may grip and/or support the housing 52 and/or a handle 54 extending from the housing 52 as the tool head 22 and the pin 24 rotate to join the components 20 to one another. In some such embodiments, the handle 54, or other portion of the housing 52, may include an actuator 55 (e.g., trigger). In some embodiments, the operator may actuate the trigger 55 to initiate the FSW process. Additionally, in some embodiments, some or all of the components of the FSW system 10 may be powered by a battery 56 (e.g., a rechargeable battery), thereby facilitating use of the FSW system 10 in a wide variety of applications.

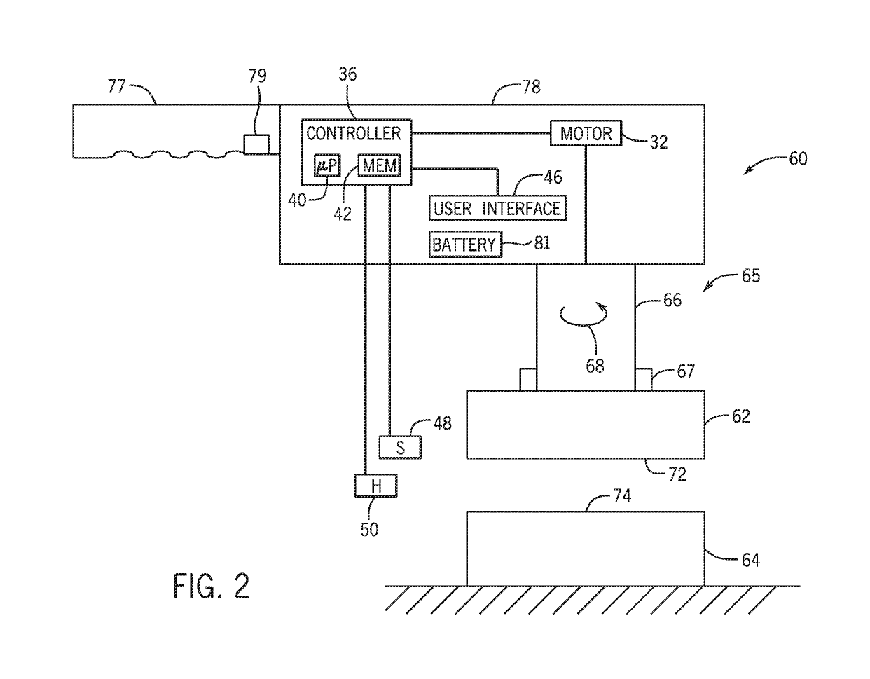

FIG. 2 illustrates an embodiment of a friction welding (FW) system 60 configured to employ a pulsed torque to join a movable component 62 (e.g., a component of a valve, such as a valve stem) and a stationary component 64 (e.g., a component of a valves, such as a valve ball or valve core) to one another. As shown, the FW system 60 includes a tool 65 having a tool head 66 (e.g., a cylindrical rotary tool) configured to support (e.g., via clamps or any suitable removable fastener 67) the movable component 62. The tool head 66 is configured to rotate, as shown by arrow 68. The FW system 10 includes an actuator, which may be similar to the actuator 32 discussed above with respect to FIG. 1, and which is configured to drive rotation of the tool head 66. As noted above, the actuator 32 may be any suitable actuator (e.g., an electric motor, air motor, hydraulic drive, combustion engine, or the like) and may be configured to apply a pulsed torque to drive the tool head 66 through multiple discrete angles of rotation, as discussed in more detail below. When a welding surface 72 of the movable component 62 is placed in contact with a welding surface 74 of the stationary component 64, such movement of the tool head 66 causes the surfaces 72, 74 to heat and to plastically deform, thereby joining the components 62, 64 to one another.

As shown, the FW system 60 also includes the controller 36, the processor 40, and the memory 42, and may have some or all of the control features discussed above with respect to FIG. 1. As noted above, in certain embodiments, the controller 36 is configured to control the actuator 32 to apply a predetermined pulsed torque (e.g., at a predetermined frequency and/or magnitude). However, in some embodiments, the controller 32 may be configured to adjust the applied pulsed torque based on various factors or inputs. Accordingly, the FW system 60 may include the user interface 46 and/or the one or more sensors 48. The controller 36 may be configured to receive user inputs (e.g., a material type) from the user interface 46 and/or signals (e.g., signals indicative of a temperature at the welding surfaces 72, 74 or the like) from the one or more sensors 48. The one or more sensors 48 may be positioned in any suitable location to obtain such signals. Based on the inputs and/or signals, the controller 36 may then determine and/or select suitable parameters (e.g., frequency and/or magnitude) for the pulsed torque to be applied by the tool head 66 and may send appropriate instructions to the actuator 32 to drive the tool head 66 according to the suitable parameters to effectively join the components 62, 64 to one another. Thus, the parameters (e.g., frequency and/or magnitude) of the pulsed torque may be set or adjusted based a material composition of one or more of the components 62, 64, a desired penetration depth (e.g., desired depth of a joint between the components 62, 64), a temperature at the welding surfaces 72, 74, or any other suitable factor or combination thereof.

Additionally, the FW system 60 may include the heating element 50, which may be configured to apply heat to the welding surfaces 72, 74 of the components 62, 64. In such cases, the temperature may not melt the components 62, 64 (e.g., the temperature is below the melting point of the material), but rather may facilitate plastic deformation of the components 62,64 and increase welding efficiency. In such cases, heat applied by the heating element 50 may be controlled by the controller 36. In some cases, the heat applied by the heating element may be controlled based on data, such as the material type, an applied pulsed torque, and/or the temperature, received at the controller 36.

As shown, in some embodiments, some or all of the actuator 32, the controller 36, the user interface 46, and/or any other components of the FW system 60 may be disposed within a housing 78. For example, the FW system 60 may be a portable and/or a handheld system, and an operator may grip and/or support the housing 78 and/or a handle 77 extending from the housing 78 as the tool head 66 rotates to join the components 62, 64 to one another. In some such embodiments, the handle 77, or other portion of the housing 78, may include an actuator 79 (e.g., trigger). In some embodiments, the operator may actuate the trigger 79 to initiate the FW process. Additionally, in some embodiments, some or all of the components of the FW system 60 may be powered by a battery 81 (e.g., a rechargeable battery), thereby facilitating use of the FW system 60 in a wide variety of applications.

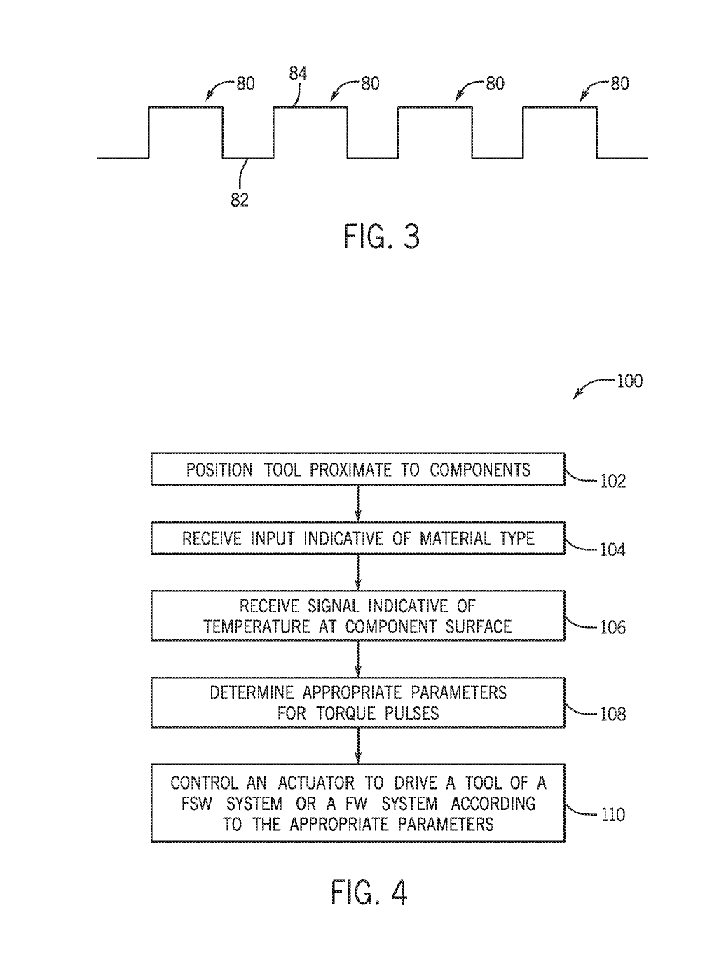

FIG. 3 is a graph showing torque pulses 80 that may be applied by the FSW system 10 of FIG. 1 or the FW system 60 of FIG. 2, in accordance with an embodiment of the present disclosure. As noted above, without the disclosed embodiments, the FW and FSW systems apply a continuous torque to join components to one another. In order to apply the continuous torque and withstand corresponding reaction forces, the FW and FSW systems utilize large and/or expensive parts. In accordance with the disclosed embodiments, applying pulsed torque may enable the disclosed FSW system 10 and FW system 60 to effectively join components with smaller, less complex, and/or less expensive parts. In some cases, the FSW system 10 and/or the FS system 60 may be portable, enabling such systems to be utilized in a wide variety of applications (e.g., repair or assembly of components in the field).

Thus, rather than continuous application of a particular torque (e.g., steady torque or maximum torque), the disclosed embodiments apply pulsed torque. Torque pulses 80 generally oscillate between a lower torque 82 and a higher torque 84. In some embodiments, the lower torque 82 may be zero torque (e.g., approximately zero torque) or a percentage of the higher torque 84 (e.g., approximately 10-90, 20-70, 30-50, 10-50, or 20-40 percent of the higher torque 84). In some embodiments, the lower torque 82 may be between approximately 0-10, 1-8, 2-7, or 3-5% of the higher torque 84. Additionally, the torque pulses 80 may have any suitable pulse frequency. For example, the pulse frequency may be between approximately 10-100, 20-90, 30-80, 40-70, or 50-60 Hertz (Hz). In some embodiments, the pulse frequency may be approximately 10, 20, 30, 40 50, 60, 70, 80, 90, 100 Hz, or more.

In the illustrated graph, the torque pulses 80 are generally uniform over time. However, it should be understood that the torque pulses 80 may have variable frequency and/or variable magnitude over time. For example, the frequency and/or the magnitude of the torque pulses 80 may gradually increase or gradually decrease over time. In other embodiments, the torque pulses 80 may follow any suitable pattern (e.g., preprogrammed or continuously adjustable or continuously variable) and have any suitable frequency and/or magnitude over time. As noted above, the controller 36 may control the actuator 32 such that the torque pulses 80 are applied according to a particular set of parameters (e.g., pulse magnitude and/or frequency), which may be pre-programmed, selected or adjusted based on various inputs (e.g., user inputs received via the user interface 46 and/or signals received via the one or more sensors 48), and/or set by an operator, for example.

FIG. 4 is a flow diagram of a method 100 for joining components via the FSW system 10 of FIG. 1 or the FW system 60 of FIG. 2, in accordance with an embodiment of the present disclosure. The methods include various steps represented by blocks. It should be noted that any of the methods provided herein may be performed as an automated procedure by a system, such as the FSW system 10 or the FW system 60. Although the flow charts illustrate the steps in a certain sequence, it should be understood that the steps may be performed in any suitable order, certain steps may be carried out simultaneously, and/or certain steps may be omitted, where appropriate.

As shown, in step 102, the tool head 22 of the FSW system 10 is positioned proximate to the adjacent surfaces 34 of the components 20 to facilitate joining the components 20 to one another. In the context of the FW system 60, the tool head 66 of the FW system 60 is coupled to the movable component 62 and is positioned proximate to the stationary component 64 to facilitate joining the components 62, 64 to one another. In step 104, an input indicative of a material type may be received at the controller 36. As discussed above, in certain embodiments, various materials may benefit from the use of certain pulsed torque parameters (e.g., amplitude and/or frequency) during FSW or FW procedures. Accordingly, the controller 36 may control the actuator 32 based at least in part on the material type, which may be input by an operator via the user interface 46, for example. In step 106, a signal indicative of a temperature at surfaces of the components (e.g., adjacent surfaces 34 of the components 20 or welding surfaces 72, 74 of the components 62, 64) may be received at the controller 36. As discussed above, the rotational and/or translational movement of the tool head 22, 66 may generate heat. It may be desirable to monitor the temperature to ensure that the components 20, 62, 64 are within a suitable range (e.g., are not approaching a melting point), for example. Such signals indicative of the temperature may enable the controller 36 to adjust the pulsed torque parameters and/or to adjust heat applied by the heating element 50 to facilitate efficient welding and to block melting of the components 20, for example.

In step 108, the controller 36 may determine appropriate parameters (e.g., amplitude and/or frequency) for the torque pulses 80. In some embodiments, the controller 36 may determine appropriate parameters for the torque pulses 80 based at least in part on the material type received in step 104 and/or the temperature received in step 106. In step 110, the controller 36 controls the actuator 32 to drive the tool head 22, 66 according to the determined appropriate parameters. For example, the controller 36 may provide signals instructing the actuator 32 to drive the tool head 22, 66 with torque pulses 80 having a particular amplitude and/or frequency. As discussed above, the controller 36 may control other aspects of the welding process based on such inputs or signals. For example, in the context of the FSW system 10, the controller 36 may provide signals instructing the actuator 32 to drive the tool head 22 at a particular transverse speed (e.g., in direction 30) based on the inputs and/or signals. In some embodiments, the controller 36 may control the heating element 50 based on the inputs and/or signals.

As discussed above, in some embodiments, the controller 36 may not receive inputs indicative of material type or signals indicative of temperature as set forth in step 102 and step 104, respectively, and adjust or select the parameters for the torque pulses 80 based on such inputs, but rather may select or access appropriate parameters for the torque pulses 80 based on preprogrammed parameters (e.g., stored in the memory 42). For example, the preprogrammed parameters may be based on the type of components being coupled (e.g., various types or characteristics of valves or components thereof being joined together). In such cases, the tool is positioned as set forth in step 102 and the controller 36 controls the actuator 32 to drive the tool head 22, 66 according to the preprogrammed parameters. In some such cases, the controller 36 may automatically control other aspects of the welding process based on preprogrammed parameters, which may be stored in the memory device 42. For example, in the context of the FSW system 10, the controller 36 may provide signals instructing the actuator 32 to drive the tool head 22 at a particular transverse speed (e.g., in direction 30) and/or may control the heating element 50 based on the preprogrammed parameters. In certain embodiments, the controller 36 may enable the operator to select from among a database of multiple preprogrammed parameters, using the user interface 46, for example, and may control the actuator 32 to drive the tool head 22, 66 according to the selected parameters.

As discussed above, without the disclosed embodiments, FSW and FW systems apply a continuous torque to join components to one another. In order to apply the continuous torque and withstand corresponding reaction forces, the FSW and FW systems utilize large and/or expensive parts. In accordance with the disclosed embodiments, applying pulsed torque may enable effective joining of components with smaller and/or less expensive parts. In some cases, the FSW and FW systems may be portable, enabling such systems to be utilized in a wide variety of applications.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system, comprising:
a tool configured to be positioned proximate to respective welding surfaces of separate components;
a tool head;
an actuator configured to drive rotation of the tool head; and
a controller comprising a memory operatively coupled to a processor, wherein the processor is configured to provide a command signal to the actuator to apply a pulsed torque to drive rotation of the tool to facilitate joining the respective welding surfaces of the separate components to one another.

2. The system of claim 1, wherein the actuator and the controller are disposed within a portable housing.

3. The system of claim 1, wherein the processor is configured to access preprogrammed pulsed torque parameters stored within the memory and to provide the command signal to the actuator based on the preprogrammed pulsed torque parameters.

4. The system of claim 1, comprising a user interface configured to receive a user input indicative of a material type of the separate components, wherein the processor is configured to receive the material type, to determine pulsed torque parameters based at least in part on the material type, and to provide the command signal to the actuator based on the determined pulsed torque parameters.

5. The system of claim 1, comprising a sensor configured to monitor a temperature proximate to the respective welding surfaces, wherein the processor is configured to receive a signal indicative of the temperature, to determine pulsed torque parameters based at least in part on the signal, and to provide the command signal to the actuator based on the determined pulsed torque parameters.

6. The system of claim 1, comprising a heating element configured to provide heat to the respective welding surfaces to facilitate joining the separate components to one another.

7. The system of claim 1, comprising a sensor configured to monitor a transverse speed of the tool head relative to the respective welding surfaces, wherein the processor is configured to receive a signal indicative of the transverse speed, to determine pulsed torque parameters based at least in part on the signal, and to provide the command signal to the actuator based on the determined pulsed torque parameters.

8. The system of claim 1, wherein the pulsed torque comprises a lower torque and a higher torque, and the lower torque is approximately 0 to 10 percent of the higher torque.

9. A method, comprising:
positioning a tool proximate to respective welding surfaces of separate components; and
providing a command signal, using a processor, to an actuator to apply a pulsed torque to drive rotation of a tool head of the tool to facilitate joining the respective welding surfaces of the separate components to one another.

10. The method of claim 9, comprising accessing, using the processor, preprogrammed pulsed torque parameters stored within a memory and providing the command signal to the actuator based on the preprogrammed pulsed torque parameters.

11. The method of claim 9, comprising:
receiving a user input indicative of a material type of the separate components at the processor;
determining, using the processor, pulsed torque parameters based at least in part on the material type; and
providing, using the processor, the command signal to the actuator based on the determined pulsed torque parameters.

12. The method of claim 9, comprising:
receiving, at the processor, a signal indicative of a temperature at the respective welding surfaces;
determining, using the processor, pulsed torque parameters based at least in part on the signal; and
providing, using the processor, the command signal to the actuator based on the determined pulsed torque parameters.

13. The method of claim 9, comprising applying heat, via a heating element, to the respective welding surfaces to facilitate joining the separate components to one another.

14. The method of claim 9, comprising:
receiving, at the processor, a signal indicative of a transverse speed of the tool relative to the respective welding surfaces;
determining, using the processor, pulsed torque parameters based at least in part on the signal; and
providing, using the processor, the command signal to the actuator based on the determined pulsed torque parameters.

15. The method of claim 9, wherein the pulsed torque comprises a lower torque and a higher torque, and the lower torque is approximately 0 to 50 percent of the higher torque.

16. A system, comprising:
a tool, comprising:
a portable housing;
a tool head coupled to the portable housing, wherein the tool head is configured to be positioned proximate to respective welding surfaces of separate components;
a controller disposed within the housing, wherein the controller comprises a processor configured to provide a command signal to an actuator to apply a pulsed torque to drive rotation of the tool head to facilitate joining the respective welding surfaces of the separate components to one another.

17. The system of claim 16, wherein the processor is configured to access preprogrammed pulsed torque parameters stored within a memory and to provide the command signal to the actuator based on the preprogrammed pulsed torque parameters.

18. The system of claim 16, comprising a heating element configured to provide heat to the respective welding surfaces to facilitate joining the separate components to one another.

19. The system of claim 16, wherein the pulsed torque comprises a lower torque and a higher torque, and the lower torque is approximately 0 to 50 percent of the higher torque.

20. The system of claim 16, wherein the tool head is configured to be manually moved by an operator transversely relative to the respective welding surfaces of the separate components to facilitate joining the separate components to one another.
